(19) United States
(12) Patent Application Publication
(10) Pub. No.: US 2026/0066516 A1
(43) Pub. Date: Mar. 5, 2026

(54) METHOD AND APPARATUS FOR CONTROLLING A RADIO FREQUENCY ENERGY ABSORPTION RATE IN A FERRITE TILE LOAD

(71) Applicant: Microwave Techniques LLC, Gorham, MI (US)

(72) Inventor: Nathan Veilleux, Gorham, ME (US)

(73) Assignee: Microwave Techniques LLC, Gorham, MI (US)

(21) Appl. No.: 19/316,174

(22) Filed: Sep. 2, 2025

Related U.S. Application Data
(60) Provisional application No. 63/689,211, filed on Aug. 30, 2024.

(51) Int. Cl. H01P 3/123

(52) U.S. Cl. CPC H01P 3/123

(57) ABSTRACT

A waveguide having a plurality of walls extending along a linear taper, each wall of the plurality of walls including a plurality of recessed portions and a plurality of ferrite tiles positioned in and adhered to the plurality of recessed portions. Each wall of the plurality of walls has a center portion and sidewall portions. The recessed portions in the center portion have a larger depth than the recessed portions near the sidewall portions.

### CROSS-REFERENCE TO RELATED APPLICATION

This application claims priority to United States Provisional Ser. No. 63/689,211 filed on Aug. 30, 2024, the entirety of which is herein incorporated by reference.

### FIELD OF THE INVENTION

The present invention relates to waveguide components, and more particularly to a waveguide load.

### BACKGROUND

Waveguide is one of the fundamental transmission media used for containing and directing radio frequency (RF) energy. High power RF systems often require absorptive terminating devices or RF loads to dissipate RF energy at points within the overall system. The energy is converted to heat and dissipated into either an air or liquid medium.

Ceramic window water loads have only a single point of failure. Industry is in need of methods for attenuating waste RF energy with reduced risk of damage to expensive hardware caused by water leaks. One common issue with current dry RF load designs is that they attenuate most of the incident energy in the front end. A strategy is needed for attenuating power at a constant rate in a controllable manner.

Accordingly, there is a need in the RF industry for a reliable dry ferrite tile load.

### SUMMARY

Disclosed is a waveguide having a plurality of walls extending along a linear taper, each wall of the plurality of walls including a plurality of recessed portions and a plurality of ferrite tiles positioned in and adhered to the plurality of recessed portions. Each wall of the plurality of walls has a center portion and sidewall portions. The recessed portions in the center portion have a larger depth than the recessed portions near the sidewall portions.

In one example, a waveguide includes an input port; an end portion; and a plurality of walls defining a channel extending between the input port and the end portion, at least one wall of the plurality of walls comprising a plurality of ferrite tiles.

In one Example, the plurality of ferrite tiles is embedded within the at least one wall. In one Example, the plurality of ferrite tiles is secured in the at least one wall with an adhesive. In one Example, the at least one wall comprises: a plurality of recessed portions; and a plurality of ferrite tiles embedded in the plurality of recessed portions.

In one Example, the plurality of recessed portions includes recessed portions having different depths. In one Example, recessed portions at a central portion of the at least one wall have a greater depth than recessed portions at edge portions of the at least one wall. In one Example, each ferrite tile of the plurality of ferrite tiles comprises a top surface opposing a bottom surface and a side surface extending between the top and bottom surfaces. In one Example, the bottom and side surfaces of each ferrite tile abut each corresponding recessed portion. In one Example, the top surface of at least a portion of the plurality of ferrite tiles is flush with a top surface of the at least one wall. In one Example, the top surface of at least a portion of the plurality of ferrite tiles sits below a top surface of the at least one wall.

In one Example, the waveguide has a linear taper extending from the input port to the end portion. In one Example, the input port is larger than the end portion. In one Example, the plurality of walls includes opposing top and bottom broad walls; and opposing side narrow walls extending between the top and bottom broad walls, wherein the top and bottom broad walls comprise a plurality of recessed portions and a plurality of ferrite tiles embedded in the plurality of recessed portions.

Also disclosed is a wall for a waveguide having a top wall opposing a bottom wall and a sidewall extending between the top and bottom walls, the top wall defining a top surface; a plurality of recessed portions having different depths; and a plurality of ferrite tiles embedded in the plurality of recessed portions.

In one Example, plurality of ferrite tiles are secured within the plurality of recessed portions with an adhesive. In one Example, the plurality of recessed portions comprises recessed portions having different depths. In one Example, the plurality of recessed portions comprises recessed portions at a central portion of the wall having a greater depth than recessed portions at edge portions of the wall.

In one Example, at least a portion of the plurality of ferrite tiles are below the top surface of the wall. In one Example, each tile of the plurality of ferrite tiles is the same size. In one Example, each tile of the plurality of ferrite tiles is separated by a portion of the wall.

### BRIEF DESCRIPTION OF THE DRAWINGS

FIG. 1 is a schematic of a waveguide of the present disclosure;

FIG. 2 is a perspective cross-sectional schematic of the present disclosure;

FIG. 3 is an exploded schematic of a portion of the waveguide of the present disclosure;

FIG. 4 is a schematic of a portion of the waveguide of the present disclosure;

FIG. 5 is a top view schematic of a portion of the waveguide of the present disclosure; and

FIG. 6 is a side cross-sectional schematic of a portion of the waveguide of the present disclosure.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

Unless otherwise specified, all percentages and amounts expressed herein and elsewhere in the specification should be understood to refer to percentages by weight. The amounts given are based on the active weight of the material. According to the present application, the term “about” means +/−5% of the reference value. According to the present application, the term “substantially free” less than about 0.1 wt. % based on the total of the referenced value.

The present disclosure relates to waveguides and waveguide walls. A waveguide is one of the fundamental transmission media used for containing and directing radio frequency (RF) energy. High power RF systems often require absorptive terminating devices or RF loads to dissipate RF energy at points within the overall system. The energy is converted to heat and dissipated into either an air or liquid medium.

To terminate and absorb high levels of RF energy in a waveguide system, a liquid cooled waveguide load is typically used. Liquid cooled waveguide loads are typically constructed either using the coolant directly as the RF absorptive material or by using a solid material such as silicon carbide or ferrite garnets to absorb the RF energy and indirectly use the liquid to cool the solid material. Each approach has advantages and disadvantages.

Waveguide RF loads that utilize the coolant media as the absorptive element are relatively inexpensive. One disadvantage is that they are sensitive to the coolant properties and performance may vary greatly if the coolant composition or temperature varies from the nominal design values. Another disadvantage is that the coolant, which is often under pressure and moving at a high flow rate, requires a barrier between the RF section that has little RF loss. This limits the choice of material, and material options may have limited mechanical properties that impact how robust the load design may be. A leak or catastrophic failure of the coolant barrier would have significant safety and financial implications.

Indirect cooling of an absorptive material addresses both primary disadvantages of loads that utilize the coolant as the absorptive media. One drawback is the cost as constructing these RF loads is expensive. The size of the waveguide and the waveguide RF load used in a system is frequency dependent, with larger waveguide sizes used for lower frequency. In smaller waveguide sizes, a single absorptive element may be used. For larger waveguide sizes, this is impractical, and an array of tiles, such as ferrite tiles, may be used to absorb the RF energy.

Current ferrite tile load designs bond tiles to the interior walls of waveguide sections. This approach is susceptible to consistent issues related to uneven heating of the ferrite tiles, failure of the adhesive, and RF arcing within the load structure. The present disclosure provides an improved ferrite tile load as a solution to the shortcomings of which is described above. The disclosed design further provides a waveguide configured to absorb all RF energy received in the input port 102 via the ferrite tiles.

In one aspect, the present disclosure includes a waveguide having pockets or recessed portions that are machined into the walls of the waveguide. These pockets allow the ferrite tiles to be recessed within the waveguide walls. This provides additional surface area for adhesion and minimizes the chance of RF arcing to the ferrite tiles. Furthermore, the presently disclosed novel design approach allows the ferrite tiles 110 to be easily set to specific recessed depths that can ensure an even heat distribution across the tile array. The power distribution within waveguides is not uniform as most of the power is concentrated along the centerline of the waveguide. In the present disclosure, the ferrite tiles 110 near the center are recessed at a deeper depth to decrease the amount of RF power coupled to the tile compared to ferrite tiles 110 closer to the edges.

One challenge associated with an RF load, a dry RF load, is that for a given uniform cross section, energy will attenuate in accordance with a logarithmic decay function. This implies that a load will need to use very thin ferrite to limit attenuation and be excessively long or suffer from high temperature at the front end. The present disclosure offers a novel solution that both minimizes length and provides uniform dissipation of RF power, and consequently thermal heat loads

In one or more examples, the present disclosure provides a solution for configuring the tiles in such a way that power is not dissipated too quickly, which overheats the front end. In another aspect, the present disclosure includes using recessed pockets housing ferrite tiles within waveguide walls to control the attenuation rate over the array of tiles in the load.

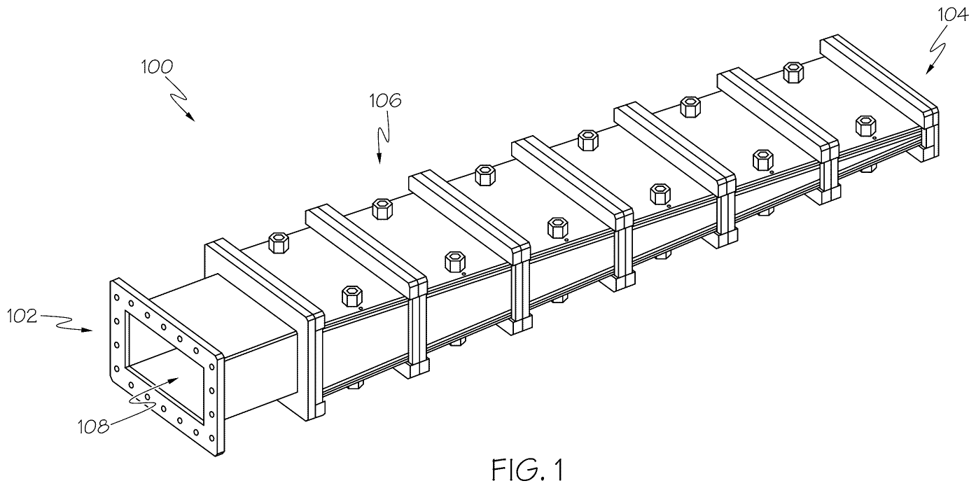

Referring to FIG. 1, disclosed is a waveguide 100. The waveguide 100 includes an input port 102 an end portion 104 opposing the input port 102. The waveguide 100 further includes a plurality of walls 106 defining a channel 108 extending between the input port 102 and the end portion 104. The plurality of walls 106 may be comprised of any material having requisite material properties, such as copper or aluminum.

In one Example, the plurality of walls 106 includes opposing top and bottom broad walls 106a, 106b, and opposing side narrow walls 106c, 106d extending between the top and bottom broad walls 106a, 106b. The waveguide 100 may have a linear taper geometry extending from the input port 102 to the end portion 104. In one example, the input port 102 is larger than the end portion 104. The end portion 104 may be capped with a flat plate or a short such that the waveguide 100 is a one port apparatus.

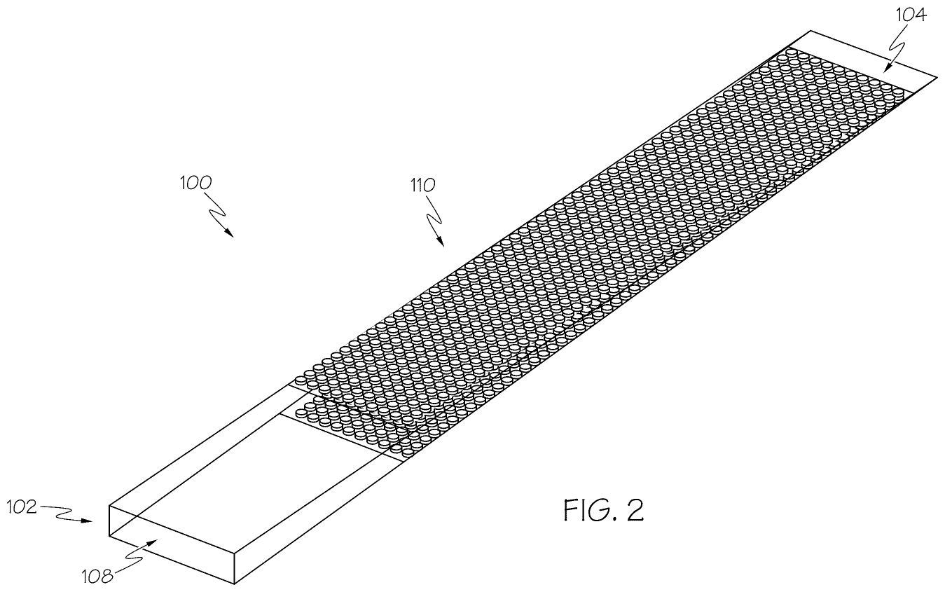

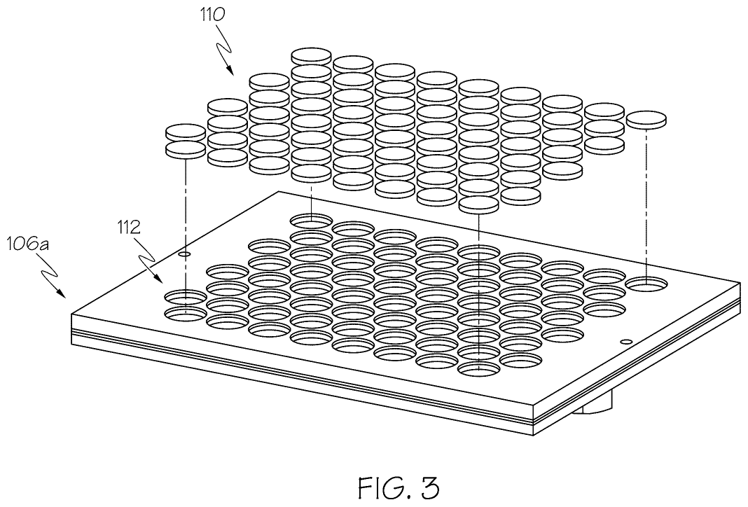

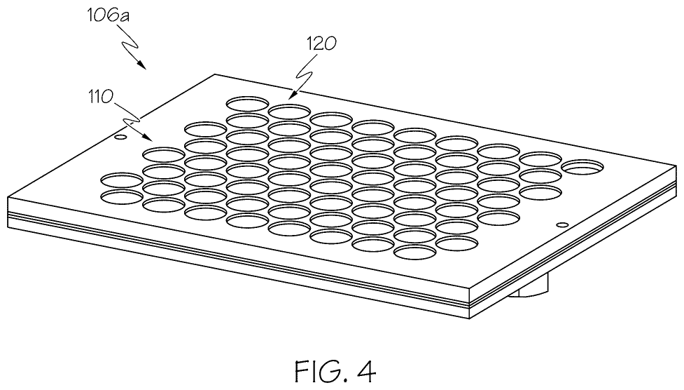

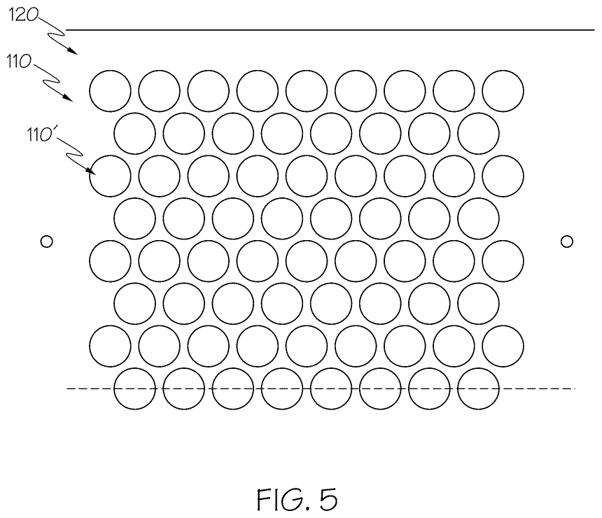

Referring to FIG. 2 to FIG. 6, in one or more examples, at least one wall 106a, 106b, 106c, 106d of the plurality of walls 106 includes a plurality of ferrite tiles 110. Each ferrite tile 110′ of the plurality of ferrite tiles 110 is embedded within the at least one wall 106a, 106b, 106c, 106d. In one example, the plurality of ferrite tiles 110 is secured in the at least one wall 106a, 106b, 106c, 106d with an adhesive.

In one or more examples, the at least one wall 106a, 106b, 106c, 106d comprises a plurality of recessed portions 112. The plurality of recessed portions 112 are sized and shaped for receiving the plurality of ferrite tiles 110 such that each ferrite tile 110′ is embedded within a recessed portion 112′ of the plurality of recessed portions 112.

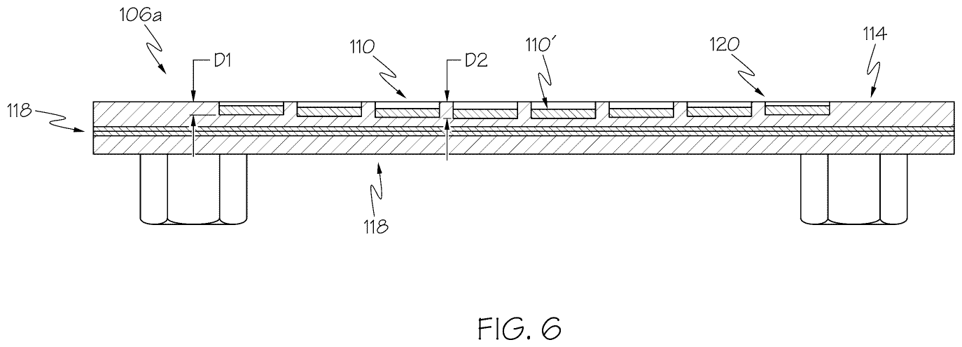

In one or more examples, the plurality of recessed portions 112 includes recessed portions having different depths, see FIG. 6. In one example, recessed portions at a central portion of the at least one wall 106a, 106b, 106c, 106d have a greater depth D2 than the depth D1 of recessed portions at edge portions of the at least one wall 106a, 106b, 106c, 106d.

In one or more examples, each ferrite tile 110′ of the plurality of ferrite tiles 110 comprises a top surface opposing a bottom surface and a side surface extending between the top and bottom surfaces. The bottom and side surfaces of each ferrite tile may abut each corresponding recessed portion. In another example, the top surface of at least a portion of the plurality of ferrite tiles 110 is flush with a top surface of the at least one wall wall 106a, 106b, 106c, 106d. In another, the top surface of at least a portion of the plurality of ferrite tiles sits below a top surface of the at least one wall 106a, 106b, 106c, 106d. In a further example, every ferrite tile 110′ of the plurality of ferrite tiles sits below a top surface of the at least one wall 106a, 106b, 106c, 106d.

Also disclosed is a wall 106a for a waveguide 100. The wall 106a has a top surface 114 opposing a bottom surface 116 and a side surface 118 extending between the top and bottom surfaces 114, 116. The top surface 114 defines a load surface 120. The wall 106a further includes a plurality of recessed portions 112 having different depths. The wall 106a further includes a plurality of ferrite tiles 110 embedded in the plurality of recessed portions 112.

In one example, plurality of ferrite tiles 110 are secured within the plurality of recessed portions 112 with an adhesive. In another example, the plurality of recessed portions 112 comprises recessed portions having different depths. The plurality of recessed portions 112 may include recessed portions at a central portion of the wall having a greater depth than recessed portions at edge portions of the wall.

In one example, at least a portion of the plurality of ferrite tiles 110 are positioned within the recessed portions 112 such that they sit below the load surface 120 of the wall 106a. In one example, each tile 110′ of the plurality of ferrite tiles 110 is the same size. In another example, each ferrite tile 110′ of the plurality of ferrite tiles 110 is separated by a portion of the wall 106a.

The power loss density of the disclosed configuration remains nearly constant for the total length of the load in the waveguide of the present disclosure, particularly compared to configurations where ferrite tiles are simply glued to the waveguide wall where they are fully exposed to RF.

As discussed above, the present disclosure utilizes a design having a linear taper. The linear taper allows for efficiently providing constant power absorption along the length of a load.

Also disclosed is a method of limiting the RF energy absorption rate using ferrite tiles. This style of load is adaptable to various waveguide sizes, frequencies, and power levels. By reconfiguring matching structure on the front of the load, power can be bifurcated to handle power levels that would otherwise necessitate exceptionally long load design.

Recessing the ferrite tiles into the wall advantageously reduces the amount of direct exposure to the RF. The depth each ferrite tile is embedded into the wall may vary based upon its location on the wall. Controlling the depth allows for control of the amount of attenuated power in every ferrite tile.

As shown in FIG. 6, the ferrite tiles 110 closer to the center of the wall 106a are more recessed than the ferrite tiles 110 closer to the edges of the wall 106a. This design accommodates for the increased attenuated power at the center of the walls compared to the amount of attenuated power at the edges of the walls. The disclosed design further provides a waveguide 100 configured to absorb all RF energy received in the input port 102 via the ferrite tiles 110.

A further benefit to embedding the ferrite tiles 110 into the walls 106 rather than adhering them to an interior surface of the walls 106 is the increased surface area for bonding. Both the back edge and side edge of each ferrite tile 110′ may be adhered to the wall with an adhesive, thus increasing the bond strength.

### EXEMPLARY CLAIMS

The disclosure may be characterized by the following Exemplary Claims.

Exemplary Claim 1. A waveguide comprising: an input port; an end portion; and a plurality of walls defining a channel extending between the input port and the end portion, at least one wall of the plurality of walls comprising a plurality of ferrite tiles.

Exemplary Claim 2. The waveguide according to Exemplary claim 1, wherein the plurality of ferrite tiles is embedded within the at least one wall.

Exemplary Claim 3. The waveguide according to Exemplary claim 2, wherein the plurality of ferrite tiles is secured in the at least one wall with an adhesive.

Exemplary Claim 4. The waveguide according to Exemplary claim 1, wherein the at least one wall comprises: a plurality of recessed portions; and a plurality of ferrite tiles embedded in the plurality of recessed portions.

Exemplary Claim 5. The waveguide according to Exemplary claim 4, wherein the plurality of recessed portions includes recessed portions having different depths.

Exemplary Claim 6. The waveguide according to Exemplary claim 4, wherein recessed portions at a central portion of the at least one wall have a greater depth than recessed portions at edge portions of the at least one wall.

Exemplary Claim 7. The waveguide according to Exemplary claim 4, wherein each ferrite tile of the plurality of ferrite tiles comprises a top surface opposing a bottom surface and a side surface extending between the top and bottom surfaces.

Exemplary Claim 8. The waveguide according to Exemplary claim 4, wherein the bottom and side surfaces of each ferrite tile abut each corresponding recessed portion.

Exemplary Claim 9. The waveguide according to Exemplary claim 4, wherein the top surface of at least a portion of the plurality of ferrite tiles is flush with a top surface of the at least one wall.

Exemplary Claim 10. The waveguide according to Exemplary claim 4, wherein the top surface of at least a portion of the plurality of ferrite tiles sits below a top surface of the at least one wall.

Exemplary Claim 11. The waveguide according to Exemplary claim 1, wherein the waveguide has a linear taper extending from the input port to the end portion.

Exemplary Claim 12. The waveguide according to Exemplary claim 11, wherein the input port is larger than the end portion.

Exemplary Claim 13. The waveguide according to Exemplary claim 1, wherein the plurality of walls comprises: opposing top and bottom broad walls; and opposing side narrow walls extending between the top and bottom broad walls; wherein the top and bottom broad walls comprise a plurality of recessed portions and a plurality of ferrite tiles embedded in the plurality of recessed portions.

Exemplary Claim 14. A wall for a waveguide comprising: a top wall opposing a bottom wall and a sidewall extending between the top and bottom walls, the top wall defining a top surface; a plurality of recessed portions having different depths; and a plurality of ferrite tiles embedded in the plurality of recessed portions.

Exemplary Claim 15. The wall according to Exemplary claim 14, wherein the plurality of ferrite tiles are secured within the plurality of recessed portions with an adhesive.

Exemplary Claim 16. The wall according to Exemplary claim 14, wherein the plurality of recessed portions comprises recessed portions having different depths.

Exemplary Claim 17. The wall according to Exemplary claim 14, wherein the plurality of recessed portions comprises recessed portions at a central portion of the wall having a greater depth than recessed portions at edge portions of the wall.

Exemplary Claim 18. The wall according to Exemplary claim 14, wherein at least a portion of the plurality of ferrite tiles are below the top surface of the wall.

Exemplary Claim 19. The wall according to Exemplary claim 14, wherein each tile of the plurality of ferrite tiles is the same size.

Exemplary Claim 20. The wall according to Exemplary claim 14, wherein each tile of the plurality of ferrite tiles is separated by a portion of the wall.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

What is claimed is:

1. A waveguide comprising:
an input port;
an end portion; and
a plurality of walls defining a channel extending between the input port and the end portion, at least one wall of the plurality of walls comprising a plurality of ferrite tiles.

2. The waveguide according to claim 1, wherein the plurality of ferrite tiles is embedded within the at least one wall.

3. The waveguide according to claim 2, wherein the plurality of ferrite tiles is secured in the at least one wall with an adhesive.

4. The waveguide according to claim 1, wherein the at least one wall comprises:
a plurality of recessed portions; and
a plurality of ferrite tiles embedded in the plurality of recessed portions.

5. The waveguide according to claim 4, wherein the plurality of recessed portions includes recessed portions having different depths.

6. The waveguide according to claim 4, wherein recessed portions at a central portion of the at least one wall have a greater depth than recessed portions at edge portions of the at least one wall.

7. The waveguide according to claim 4, wherein each ferrite tile of the plurality of ferrite tiles comprises a top surface opposing a bottom surface and a side surface extending between the top and bottom surfaces.

8. The waveguide according to claim 4, wherein the bottom and side surfaces of each ferrite tile abut each corresponding recessed portion.

9. The waveguide according to claim 4, wherein the top surface of at least a portion of the plurality of ferrite tiles is flush with a top surface of the at least one wall.

10. The waveguide according to claim 4, wherein the top surface of at least a portion of the plurality of ferrite tiles sits below a top surface of the at least one wall.

11. The waveguide according to claim 1, wherein the waveguide has a linear taper extending from the input port to the end portion.

12. The waveguide according to claim 11, wherein the input port is larger than the end portion.

13. The waveguide according to claim 1, wherein the plurality of walls comprises:
opposing top and bottom broad walls; and
opposing side narrow walls extending between the top and bottom broad walls;
wherein the top and bottom broad walls comprise a plurality of recessed portions and a plurality of ferrite tiles embedded in the plurality of recessed portions.

14. A wall for a waveguide comprising:
a top surface opposing a bottom surface and a side surface extending between the top and bottom surfaces, the top surface defining a load surface;
a plurality of recessed portions having different depths; and
a plurality of ferrite tiles embedded in the plurality of recessed portions.

15. The wall according to claim 14, wherein the plurality of ferrite tiles is secured within the plurality of recessed portions with an adhesive.

16. The wall according to claim 14, wherein the plurality of recessed portions comprises recessed portions having different depths.

17. The wall according to claim 14, wherein the plurality of recessed portions comprises recessed portions at a central portion of the wall having a greater depth than recessed portions at edge portions of the wall.

18. The wall according to claim 14, wherein at least a portion of the plurality of ferrite tiles are below the load surface of the wall.

19. The wall according to claim 14, wherein each tile of the plurality of ferrite tiles is the same size.

20. The wall according to claim 14, wherein each tile of the plurality of ferrite tiles is separated by a portion of the wall.
